(19) United States
(12) Patent Application Publication
(10) Pub. No.: US 2003/0081916 A1
(43) Pub. Date: May 1, 2003

(54) Transmission cable, end cap and method

(76) Inventor: Richard H. Norris, Powder Springs, GA (US)

Correspondence Address: Daniel J. Santos, Esq., Thomas, Kayden, Horstemeyer & Risley, L.L.P., Suite 1750, 100 Galleria Parkway, Atlanta, GA, 30339, US

(21) Appl. No.: 10/036,064

(22) Filed: Oct. 19, 2001

(51) Int. Cl. G02B 6/44

(52) U.S. Cl. 385/100; 385/136

(57) ABSTRACT

The transmission cable is disclosed herein that includes the transmission medium; and outer jacket disposed about the transmission medium, and end cap swaged on the end of the transmission cable. Preferably, the end cap comprises a shape that aids in installation of the transmission cable. Also disclosed herein is a method of producing a transmission cable that includes the steps of: providing a transmission cable including a transmission medium, an outer jacket disposed about the transmission medium, and an end; and swaging an end cap on the end of the transmission cable. A method of installing a transmission cable is also disclosed herein, including the steps of: providing a transmission cable; and installing the cables. The step of installing the cable may be performed by either jetting installation, using an aerodynamically-shaped end cap on the cable, or by shaping the end cap in a manner so that an apparatus for pulling the cable may be attached to the end cap, and that the cable may be pulled through the space in which it is being installed.

### TECHNICAL FIELD

The present invention is generally related to transmission cables and, more particularly, is related to an apparatus and method for improving end caps on transmission cables.

### BACKGROUND OF THE INVENTION

In the manufacture of communication cables, it is often desirable to cap the end of the communications cable so as to seal the end and protect the transmission media. FIG. 1 is an example of one conventional end plug 20 disposed on the end region 22 of a known transmission cable 10. The transmission cable 10 depicted in FIG. 1 is a fiber optic cable 10 known in the art, including ribbons of optical fibers 14 disposed within a core tube 16. Around the core tube 16 is disposed an outer jacket 20 with a plurality of strength members 18 embedded therein. Traditionally, to apply the end plug 12, as known in the art, an operator must prepare the end 22 of the cable 10 by stripping back the jacket 20, any armor (not shown), strength members 18, water blocking tapes (not shown) and core tubes 16; expose approximately six inches of the fiber ribbons 14; clean off any residual filling compound on the ribbons 14; attach a cardboard conical mold (not shown); mix and apply an epoxy or resin-type material to unitize all cable components; and allow the epoxy to harden. This process can take up to 20 minutes per cable to complete, and often during capacity production of a cable 10, this station in the manufacturing process is the bottleneck. Thus, the typical resin or epoxy-type end plug uses a process that is labor- and time-intensive.

An additional problem with the end plug 12 as known in the art includes a twisting and disarrangement of the optical fiber ribbons 14 when the resin is applied to the end portion 22 of the cable 10, as can be seen in FIG. 1. This displacement of the optical fiber ribbons 14 can lead to damage to ribbons 14 proximate and away from the cable end 22. The known end plug 12 does not afford the interior portion of the cable 10 complete protection from the external environment.

FIG. 2 shows a second end plug known in the art in the form of a screw-on cap 30 that is often used on known transmission cables 10. The end cap 30 is manufactured by and commercially available from Sherman and Reilly, Inc. in Chattanooga, Tenn. The end cap 30 includes a barrel 32 and an aerodynamically shaped, or conical, end 36 that aids in jetting installation in the field of the cable 10. The end cap 30 also includes threads 34 disposed therein for threadedly fastening the barrel 32 in the end cap 30 to the cable 10. Problems besetting use of the end cap 30 include its inability to properly hold and secure cable interior components such as the optical fiber ribbons 14, core tube 16, and strength members 18 (FIG. 1), as well as not completely sealing the interior components of the cable 10 from the external environment. Further, the process of threadedly fastening the end cap 30 to the cable 10 may damage the cable jacket 20 and in the presence of significant tensile stresses could be torn from the cable jacket 20 thereby damaging the cable 10.

Thus, a heretofore unaddressed need exists in the industry to address the aforementioned deficiencies and inadequacies.

### SUMMARY OF THE INVENTION

The present invention provides an apparatus and method for improving end caps on transmission cables.

Briefly described, one embodiment of the system, among others, can be implemented as follows. A transmission cable is disclosed herein that includes a transmission medium, an outer jacket disposed about the transmission medium, and end, and an end plug swaged on the end of the transmission cable. The end plug may be made of, for example, but is not limited to, a metal, e.g., aluminum. The end plug may be in a shape that aids in installation of the transmission cable, such as a conical shape. In a preferred embodiment, the end plug captures all components of the transmission cable in a manner that renders them substantially immovable.

The present invention can also be viewed as providing methods for producing a transmission cable and installing a transmission cable. In this regard, one embodiment of such a method, among others, can be broadly summarized by the following steps: providing a transmission cable including a transmission medium, an outer jacket disposed about the transmission medium, and an end; and swaging an end cap on the end of the transmission cable. In one embodiment, the step of swaging the end cap includes capturing the transmission medium in a manner that renders it substantially immovable. Further, in this embodiment, the transmission medium is an optical fiber. The method of installing a transmission cable can be broadly summarized by the following steps: providing a transmission cable, wherein the cable includes an aerodynamically-shaped end cap swaged on the end of the cable; and installing the cable by jetting installation. The method of installing the transmission cable may also include the steps of providing a means for pulling the cable; providing a transmission cable, wherein the end of the cable includes an end cap swaged on end of the cable, and an eye on the end cap; attaching the means for pulling the cable to the eye of the end cap; and pulling the cable through a space in which it is being installed.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a cutaway perspective view of a transmission cable with an end plug, both of which are known in the art.

FIG. 2 is a perspective view of an alternate end plug.

FIG. 3 is a perspective view of a transmission cable of the present invention with a novel end cap swaged thereon.

FIG. 4 is a perspective view of an end cap of the present invention of FIG. 3.

FIG. 5 is a cutaway side view of the end cap of the present invention of FIG. 4.

FIG. 6 is a perspective view of the end cap of the present invention before its placement on the transmission cable, thereby forming the transmission cable of FIG. 3.

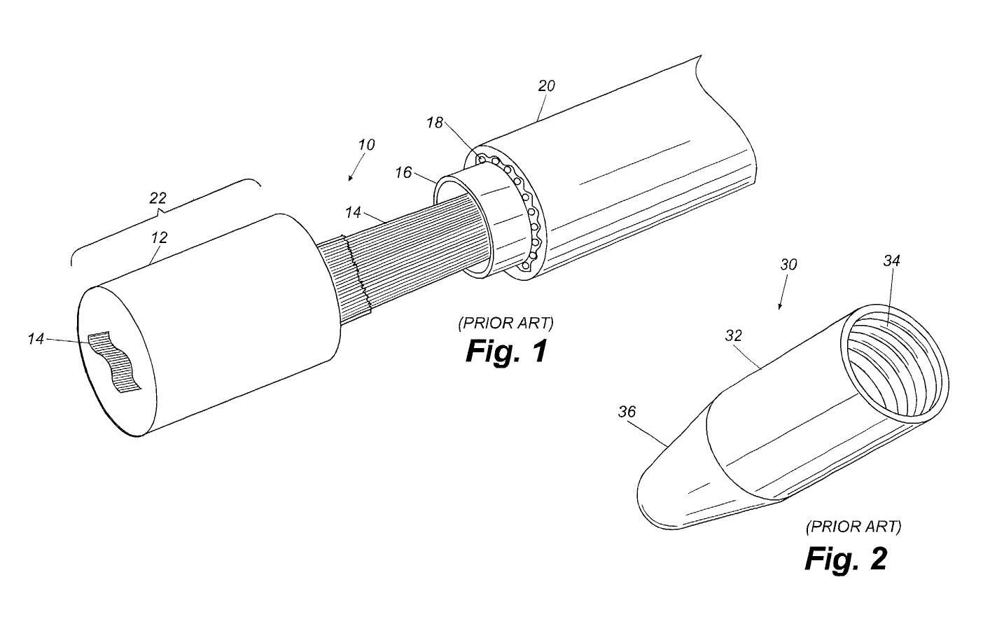

### DETAILED DESCRIPTION OF THE PREFERRED EMBODIMENT

Embodiments of the invention include a transmission cable with a novel end cap swaged thereon, the novel end cap itself, a method of producing a cable with the novel end cap swaged thereon, and a method of installing a cable with novel end cap swaged thereon. “Swaged” for the purposes of this document means the uniform, permanent reduction of the cross-section of the end cap/cable by application of an external hydrostatic strain.

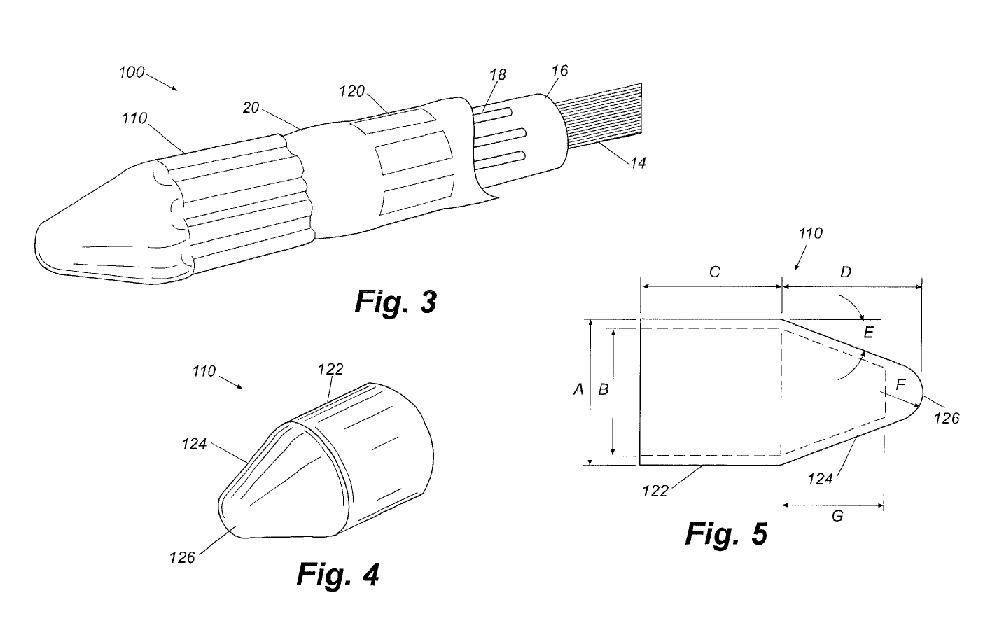

FIG. 3 shows a transmission cable 100 of one embodiment of the invention. The cable includes an end cap 110 swaged on one end of the cable 100, an outer jacket 20 that may include optional crimping 120 which marks where the swaging machine has gripped the transmission cable 100. Disposed within the cable 100 may also be strength members 18, a core tube 16, and at least one transmission medium, for example optical fiber ribbons 14, disposed within the core tube 16. While the transmission media shown in FIG. 3 are optical fiber ribbons 14, it can be envisioned by one skilled in the art that other types of transmission media may be used, for example but not limited to, optical fibers, copper wires, shielded twisted pair, unshielded twisted pairs, and coaxial.

FIG. 4 depicts another embodiment of the invention, the end cap 110. The end cap may include a cylinder portion 122, a conical portion 124, and a tip 126. While the tip 126 is depicted in FIG. 4 as rounded, it can be envisioned by one skilled in the art that any similar type configuration may be used, for example, but not limited to, a square, a rectangle, or ovoid- or triangular-type configurations may be used.

FIG. 5 is a cutaway side view of the end plug 110 of FIG. 4. The cylinder portion 122 of the end cap 110 may have a range of lengths, thicknesses and widths. Table 1 below depicts one exemplary outer diameter A, an exemplary inner diameter B, and exemplary length C. One skilled in the art can envision other dimensions and ratios of dimensions that may be used, depending upon the desired application of the end cap. The conical portion 124 of the end cap 110 may also have a wide range of lengths, inner diameters, and angles of deflection (cone angle) from the cylindrical portion 122. Table 1 below depicts exemplary outer length D, inner length G, and cone angle E. Similarly, the tip 126 of the end cap 110 may have a wide range of tip radii. Table 1 depicts exemplary tip radius F of two embodiments of the present invention.

TABLE 1
Exemplary End Cap Dimensions

| “B” - Inner | “A” - Outer | “C” - | “D” - | “E” - | | “G” - |
|---|---|---|---|---|---|---|
| Diameter | Diameter | Cylinder | Cone | Cone | “F” - | Interior Tip |
| Cap | Cap | length | Length | Angle | Tip Radius | Bore |
| 1.030 | 1.120 | 1.000 | 1.000 | 21° | 0.250 | 0.750 |
| 0.770 | 0.860 | 1.000 | 1.000 | 13° | 0.250 | 0.750 |

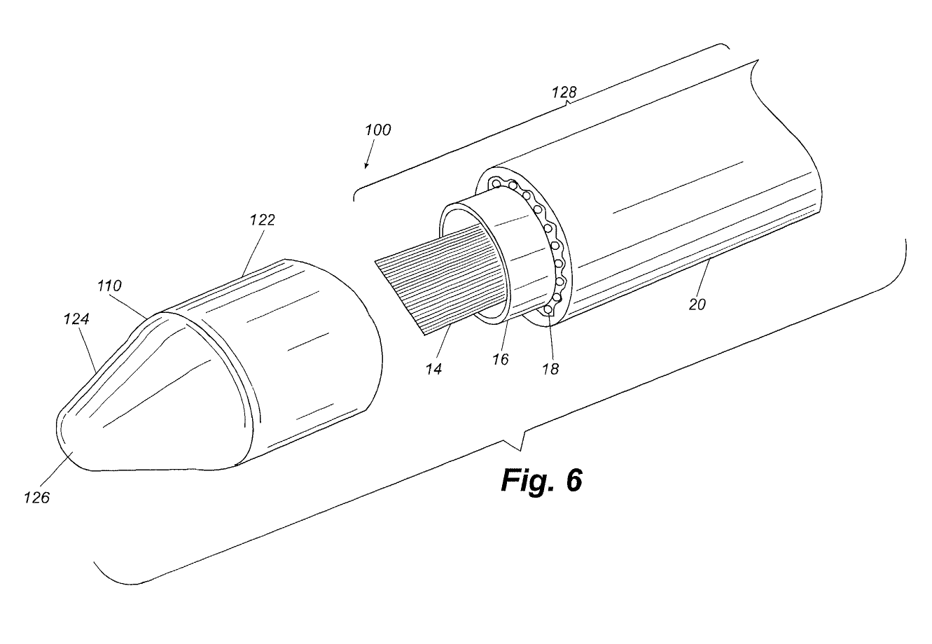

An embodiment of the invention includes a method of producing the transmission cable 100. The method includes the steps of providing a portion of transmission cable 100, such as that depicted in FIG. 6 as 100, wherein the transmission cable 100 includes a transmission medium 14, an outer jacket 20 disposed about the transmission medium 14, and an end 128; and swaging an end cap 110 on the end 128 of the transmission cable 100. FIG. 6 depicts the process of placing the end cap 1 10 on the end 128 of the cable 100, thus preparing it for the swaging step. In a preferred embodiment, the end cap 110 is placed over all elements of the end 128 of the cable 100, including the outer jacket 20, the core tube 16, and the transmission medium 14. Preferably, the end cap 110 is swaged on the end 128 of the cable 100 in such a way that it grips all of the cable elements, including the transmission medium 14, in such a way as to render them immovable, or substantially immovable. Further, in a preferred embodiment, when the transmission medium 14 comprise optical fiber ribbons, the optical fiber ribbons are not displaced as with known end plugs.

Alternative embodiments include swaging the end cap 110 over only that portion of the end 128 of the cable 110 that is exposed, i.e., the core tube 16 and the transmission medium 14, or the transmission medium 14 only. Because it is not necessary in the method of producing the transmission cable 100 to strip away the outer jacket 20, strength members 18, core tube 16, etc., this saves both time and labor cost in the manufacturing process of the transmission cable.

Another embodiment of the present invention is a method of installing a transmission cable 100, which includes the steps of providing a transmission cable 100 that has an aerodynamically-shaped end cap 110 swaged on end of the cable, and then installing the cable 100 by a jetting installation. As noted before, in jetting installation, a jet of air is blown through the area in which the cable 100 is being placed, and the cable 100 is then pushed on a layer of air into the space to which the cable 100 is being placed. An alternative embodiment of the method for installing the transmission cable 100 includes providing an apparatus that is capable of pulling the cable 100, for example but not limited to, a chain, a rope, a string, or cable; providing a transmission cable 100, wherein the cable 100 includes an end cap 110 swaged on the end of the cable 100, and either an eye or a ring on the end cap 110; attaching the apparatus configured to pull the cable 100 to the eye or the ring of the end cap 110; and pulling the cable 100 through the space in which it is being installed. In this instance, where the cable 100 is not being installed by jetting installation, but rather by means of a pulling mechanism, the shape of the end cap 110 may be of any shape, including but not limited to, for example a circle, oval, rectangle, square, triangle, or any other size or shape that enables it to be used for the purpose of protecting the end 128 of the cable 100 and gripping the outer jacket 20 on and the contents of the cable 100.

The swaging machine that may be used to swage the end cap 110 on the end 128 of the cable 100 may be any swaging machine known in the art that is typically used for high pressure lines, for example, air conditioning lines in cars, etc. A typical swaging machine that may be used in the method disclosed herein is a Finn Power model P 20 Mid Range Swaging machine, manufactured by and commercially available from Finn-Power, Inc. of Arlington Heights, Ill. Thus, the cable 100 and the novel end cap 110 provide the advantages of both an aerodynamic shape that may be used in jetting installation, and an ability to grasp or grip all components of the transmission cable thereby relieving pull-back of the transmission medium 14 inside the core 16 by elongation and tensile stresses which occur during pulling installation. Further, as noted above, the end cap 110 and the method of producing the cable 100 disclosed herein saves both time and cost in the processing and manufacture of transmission cables 100.

It should be emphasized that the above-described embodiments of the present invention, particularly, any “preferred” embodiments, are merely possible examples of implementations, and are merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by following claims.

Therefore, having thus described the invention, at least the following is claimed:

1. A transmission cable having an end, the transmission cable comprising:
a transmission medium;
an outer jacket disposed about the transmission medium; and
an end cap swaged on said end of the transmission cable.

2. The transmission cable of claim 1, wherein the end cap comprises a metal.

3. The transmission cable of claim 1, wherein the end cap comprises aluminum.

4. The transmission cable of claim 1, wherein the end cap comprises a shape that aids in installation of the transmission cable.

5. The transmission cable of claim 1, wherein the end cap comprises a conical shape.

6. The transmission cable of claim 1, wherein the end cap comprises a ring configured to aid in pull-through installation of the cable.

7. The transmission cable of claim 1, wherein the end cap comprises an eye configured to aid in pull-through installation of the cable.

8. The transmission cable of claim 1, wherein the end cap captures the transmission medium in a manner that renders it substantially immovable.

9. The transmission cable of claim 1, wherein the end cap completely seals internal components of the cable from external environment.

10. The transmission cable of claim 1, wherein the transmission cable further comprises:
a water-blocking material disposed about the transmission medium;
a core tube disposed between the transmission medium and the outer jacket; and
strength members disposed about the core tube, wherein the transmission medium, outer jacket, water-blocking material, core tube and strength members comprise the components of said cable.

11. The transmission cable of claim 10, wherein the end cap captures all components of the transmission cable in a manner that renders them substantially immovable.

12. The transmission cable of claim 1, wherein the transmission medium is an optical fiber.

13. A method of producing a transmission cable having an end, and the method comprising the steps of:
providing a transmission cable including a transmission medium and an outer jacket disposed about the transmission medium; and
swaging an end cap on said end of the transmission cable.

14. The method of claim 13, wherein the step of providing a transmission cable comprises:
providing a transmission cable including an optical fiber.

15. The method of claim 13, wherein the step of swaging an end cap comprises:
swaging a metal end cap on the transmission cable.

16. The method of claim 13, wherein the step of swaging an end cap comprises:
swaging an aluminum end ap on the transmission cable.

17. The method of claim 13, wherein the step of swaging an end cap comprises:
swaging an end cap on the transmission cable, wherein the end cap is shaped to aid in installation of the transmission cable.

18. The method of claim 13, wherein the step of swaging an end cap comprises:
swaging an end cap on the transmission cable, wherein the end cap comprises a conical shape.

19. The method of claim 13, wherein the step of swaging an end cap comprises:
swaging an end cap on the transmission cable, wherein the end cap comprises a ring

20. The method of claim 13, wherein the step of swaging an end cap comprises:
capturing the transmission medium in a manner that renders it substantially immovable

21. A method of installing a transmission cable, comprising:
providing a transmission cable, wherein the cable includes
an aerodynamically-shaped end cap swaged on an end of the cable; and installing the cable by jetting installation.

22. A method of installing a transmission cable, comprising:
providing a means for pulling the cable;
providing a transmission cable, wherein the cable includes
an end cap swaged on an end of the cable, and
an eye on the end cap;
attaching the means for pulling the cable to the eye of the end cap; and
pulling the cable through a space in which it is being installed.
